(19) United States
(12) Patent Application Publication
(10) Pub. No.: US 2009/0214946 A1
(43) Pub. Date: Aug. 27, 2009

(54) NEGATIVE ELECTRODE FOR LITHIUM ION BATTERY AND LITHIUM ION BATTERY USING THE SAME

(76) Inventors: Xi Shen, Shenzhen (CN); Yu Xia, Shenzhen (CN); Fuzhong Pan, Shenzhen (CN)

Correspondence Address: BRINKS HOFER GILSON & LIONE, P.O. BOX 10395, CHICAGO, IL, 60610, US

(21) Appl. No.: 12/273,356

(22) Filed: Nov. 18, 2008

(30) Foreign Application Priority Data
Feb. 22, 2008 (CN) 200810008301.3

(51) Int. Cl. H01M 2/02; H01M 4/48; H01M 4/52; H01M 4/50; H01M 4/62

(52) U.S. Cl. 429/176; 429/231.5; 429/221; 429/223; 429/224; 429/231; 429/217; 429/220; 977/742

(57) ABSTRACT

A negative electrode for a battery comprises a current collector, an inner coating on the current collector, and an outer coating on the inner coating. The inner and outer coatings comprise a carbonaceous material, and a lithium titanium oxide compound. The weight percentage of the carbonaceous material is higher than that of the lithium titanium oxide compound in the inner coating. The weight percentage of the carbonaceous material is lower than that of the lithium titanium oxide compound in the outer coating. The total weight percentage of the carbonaceous material in the combined inner and outer coatings is higher than the total weight percentage of the lithium titanium oxide compound in the combined inner and outer coatings.

The present application claims priority to Chinese Patent Application No. CN200810008301.3, filed Feb. 22, 2008, the entirety of which is hereby incorporated by reference.

### FIELD OF THE DISCLOSURE

The present disclosure relates to a negative electrode for lithium ion battery and a lithium ion battery comprising the same.

### BACKGROUND OF THE DISCLOSURE

Presently, most of the commercial lithium ion batteries use carbonaceous materials in the negative electrode. The carbonaceous materials are abundant and have a high lithium ion storage capacity. Furthermore, lithium ions can rapidly carry out intercalation and deintercalation reactions in carbonaceous materials. Therefore the carbonaceous material plays an important role in lithium ion batteries. However due to a low diffusion rate of lithium ions in carbonaceous materials, the lithium ion batteries using carbonaceous materials have some shortcomings, such as a poor high-rate discharge-charge performance. During the high-rate discharging-charging process, the lithium ion secondary batteries show severe polarizations, i.e. lithium dendrites are formed on the carbon electrode surface and thus cause safety issue.

Numerous studies have been undertaken in order to improve the high-rate discharge-charge performance of lithium ion secondary batteries. It has been found that when the lithium titanium oxide compound is used in the negative electrode, lithium ions exhibit a high diffusion rate and an electric potential of 1.55 V relative to metal lithium, and there is no formation of solid electrolyte interface films. Therefore lithium titanium oxide has potential applications in the field of negative electrode active materials. However, due to its poor electronic conductivity, lithium titanium oxide causes a poor high-rate discharge-charge performance in the battery. To solve this problem, conductive agents have been added into the negative electrode materials. For example, Chinese Patent No. CN 1841820A discloses a non-aqueous electrolyte secondary battery, which uses spinel lithium titanate and a carbonaceous material in the negative electrode. Carbonaceous materials have an interlayer-spacing value (d₀₀₂) of about 0.335-0.340 nm and a volume density less than about 0.1 g/cm³. The method for preparing the negative electrode comprises: (1) mixing spinel lithium titanate, a carbonaceous material and a binder to form a negative electrode material; (2) loading the negative electrode materials on a negative electrode current collector; and (3) pressing the current collector to provide a negative electrode. The carbonaceous material has a content of about 5-20% by the total weight of the negative electrode materials.

Another Chinese Patent, namely CN 1728442A, discloses a non-aqueous electrolyte secondary battery, which comprises a non-aqueous electrolyte and a negative electrode in a case. The non-aqueous electrolyte comprises linear sulfite esters. The negative electrode uses lithium titanium oxide as a negative electrode active material and a carbonaceous material as a conductive agent, capable of absorbing and releasing lithium metal or ions. The method for the negative electrode preparation comprises: (1) preparing a slurry with about 70-96% of lithium titanium oxide by weight, about 2-28% of a carbonaceous material by weight, and about 2-28% of a binder by weight; (2) coating the slurry on a current collector; (3) drying, pressing, and cutting the coated current collector to provide a negative electrode.

The utilization of lithium titanium oxide as a negative electrode active material and a carbonaceou material as a conductive agent increases the electric conductivity of the negative electrode, and thus improves the high-rate discharge-charge performance of the battery. But due to the low specific capacity (the theoretic capacity of 175 mAh/g) of lithium titanium oxide, the prepared lithium ion battery may have a low capacity.

### SUMMARY OF THE DISCLOSURE

In one aspect, a negative electrode for a battery comprises a current collector, an inner coating on the current collector, and an outer coating on the inner coating. The inner and outer coatings comprise a carbonaceous material, and a lithium titanium oxide compound. The weight percentage of the carbonaceous material is higher than that of the lithium titanium oxide compound in the inner coating. The weight percentage of the carbonaceous material is lower than that of the lithium titanium oxide compound in the outer coating. The total weight percentage of the carbonaceous material in the combined inner and outer coatings is higher than the total weight percentage of the lithium titanium oxide compound in the combined inner and outer coatings.

In another aspect, a negative electrode for a battery comprises a current collector, an inner coating on the current collector, and an outer coating on the inner coating. The inner and outer coatings comprise a carbonaceous material, and a lithium titanium oxide compound. The weight percentage of the carbonaceous material is higher than that of the lithium titanium oxide compound in the inner coating. The weight percentage of the carbonaceous material is lower than that of the lithium titanium oxide compound in the outer coating. The total weight percentage of the carbonaceous material in the combined inner and outer coatings is higher than the total weight percentage of the lithium titanium oxide compound in the combined inner and outer coatings. Each of the inner and outer coatings comprises one layer.

In yet another aspect, a lithium ion battery comprises a negative electrode. The negative electrode comprises a current collector, an inner coating on the current collector, and an outer coating on the inner coating. The inner and outer coatings comprise a carbonaceous material, and a lithium titanium oxide compound. The weight percentage of the carbonaceous material is higher than that of the lithium titanium oxide compound in the inner coating. The weight percentage of the carbonaceous material is lower than that of the lithium titanium oxide compound in the outer coating. The total weight percentage of the carbonaceous material in the combined inner and outer coatings is higher than the total weight percentage of the lithium titanium oxide compound in the combined inner and outer coatings. The lithium ion battery further comprises a positive electrode. The positive electrode comprises a current collector, and a coating on the current collector. The lithium ion battery further comprises a separator, an electrolyte, and a case. The negative electrode, the positive electrode, the separator, and the electrolyte are disposed in the case.

### DETAILED DESCRIPTION OF THE DISCLOSURE

The present disclosure provides a negative electrode for lithium ion battery, preferably possessing a high capacity, a high voltage, and a desirable high-rate discharge-charge and safety performance. The disclosure also describes a lithium ion battery comprising the same. It has been found that by increasing carbonaceous material content in the negative electrode material, the prepared battery has both increased capacity and voltage, but the battery has significantly lowered cycle performance, high-rate discharge-charge performance and safety performance (see the following comparison example 1).

The present disclosure provides a negative electrode for a lithium ion battery and a lithium ion battery comprising the same. The negative electrode comprises a current collector, an inner coating on the current collector, and an outer coating on the inner coating. The inner and outer coatings comprise a carbonaceous material, and a lithium titanium oxide compound. The inner and outer coatings may also comprise a binder and optionally a conductive agent. The total weight percentage of the carbonaceous material in the combined inner and outer coatings is higher than that of the lithium titanium oxide compound in the combined inner and outer coatings. In the inner coating, the weight percentage of the carbonaceous material is higher than that of the lithium titanium oxide compound; while in the outer coating, the weight percentage of the carbonaceous material is lower than that of the lithium titanium oxide compound. The inner and outer coatings comprise one or more layers.

In one embodiment of the invention, the ratio of the total weight percentage content of the carbonaceous material to that of lithium titanium oxide compound is higher than about 1, preferably about (1.5-100):1. In the inner coating, the ratio of the weight percentage of lithium titanium oxide compound to that of the carbonaceous material can be about (0-0.25): 1. In the outer coating, the ratio of the weight percentage of the carbonaceous material to that of lithium titanium oxide compound can be about (0-0.25):1.

In one embodiment of the invention, each of the inner and outer coatings comprises one layer. The inner coating comprises about 80-95% of a carbonaceous material by weight, about 0-16% of lithium titanium oxide compound by weight, about 1-10% of a binder by weight, and about 0-8% of a conductive agent by weight. The outer coating comprises about 0-16% of a carbonaceous material by weight, about 80-95% of lithium titanium oxide compound, about 1-10% of a binder by weight, and about 0-8% of a conductive agent by weight.

In one embodiment of the invention, the ratio of the thickness of the inner coating to that of the outer coating is higher than about 1, and preferably about 50:(25-2). The thickness of the inner coating can be about 0.070-0.120 mm. The thickness of the outer coating can be about 0.003-0.040 mm.

In one embodiment of the present invention, the carbonaceous material can be any common carbonaceous materials, such as one or more of graphite, carbon black, pyrolyzed carbon, coke, activated carbon, carbon fiber, petroleum coke, hard carbon, carbon nanotubes, carbon obtained by high temperature oxidation of polyyne polymer material; or organic polymer sintered products. The organic polymer sintered product can be a product resulted by sintering and carbonizing bakelite resin, or epoxy resin, etc. The carbonaceous material in the present disclosure is preferably graphite.

The lithium titanium oxide compound can be any compound comprising lithium element, titanium element and oxygen element, such as a lithium titanium oxide material with chemical formula of Li₃₊₃ₓTi_{6-3x-y}M_{y}O₁₂, wherein x and y are molar fractions, 0≦x≦⅓, and 0≦y≦0.25; and M is selected from a group consisting of Fe, Al, Ca, Co, B, Cr, Ni, Mg, Zr, Ga, V, Mn, Zn, and a combination thereof.

Conductive agents can increase the conductivity of electrodes and lower the internal resistance of the battery, and therefore improve the high-rate discharge-charge performance. The negative electrode material in the present disclosure preferably comprises a conductive agent. The conductive agent can be nickel powder and/or copper powder.

In one embodiment of the present invention, the binder can be various binders used in the negative electrode of the lithium ion secondary batteries, such as one or more of polyvinylidene fluoride (PVDF), polytetrafluoroethylene (PTFE), sodium carboxymethylcellul-ose (CMC), and styrene-butadiene rubber (SBR). A binder is preferably a mixture of a hydrophobic binder and a hydrophilic binder. Any suitable ratio of the hydrophobic binder to the hydrophilic binder can be used, and can be determined as needed. For example, the weight ratio of the hydrophilic binder to the hydrophobic binder can be about (0.3:1) to about (1:1). The binder can be applied in a form of aqueous solution, emulsion, or solid, preferably in an aqueous solution or emulsion. Any suitable concentrations of the hydrophilic binder solution and the hydrophobic binder emulsion can be used, and can be adjusted according to the viscosity of the mixture and the operation requirements. For example, the hydrophilic binder solution can have a concentration of about 0.5-4% by weight, and the hydrophobic binder emulsion can have a concentration of about 10-80% by weight. The hydrophobic binder can be PTFE, SBR, or a mixture thereof. The hydrophilic binder can be one or more of hydroxypropylmethylcellulose, sodium carboxymethylcellulose, hydroxyethylcellulose, and polyvinyl alcohol.

The current collector can be any currently available collectors for the negative electrodes, such as a copper foil.

The negative electrode can be prepared by a conventional method. For example, a mixture of a solvent and a negative electrode material with a weight percentage of a carbonaceous material higher than that of lithium titanium oxide compound is firstly coated onto a conductive substrate, and then the coated substrate is dried and rolled to provide a primary electrode plate with a first coat. Another mixture of a solvent and a negative electrode material with a weight percentage of carbonaceous material lower than that of lithium titanium oxide compound is further coated onto the previously coated electrode plate. The coated electrode plate is dried, and rolled to provide an electrode plate with a second coat. The obtained electrode plate is cut to an appropriate size to provide a negative electrode.

The solvent can be one or more of any solvents known to those skilled in the art, such as N-methyl-2-pyrrolidinone, water, water-soluble solvents, or a mixture thereof. The water-soluble solvents comprises C₁₋₆ alkyl alcohols, such as methanol, ethanol, propanol, butanol, pentanol, and hexanol; acetone; and N,N-dimethylformamide. The amount of the solvent should be sufficient to allow the slurry to be coated on the current collector.

The drying and rolling conditions can be any conditions well known to those skilled in the art. For example, the drying temperature is usually in a range of about 60-120° C., preferably about 80-110° C. The drying time is about 0.5-5 hours.

In another aspect, the present disclosure further provides a lithium ion battery, comprising a negative electrode, a positive electrode, a separator, an electrolyte, and a case. The negative electrode, the positive electrode, the separator, and the electrolyte are sealed in the case, wherein the negative electrode is as described above.

The positive electrode can be the any positive electrodes well known to those skilled in the art, such as a positive electrode current collector coated with a positive electrode material. Any suitable positive electrode material can be used. The positive electrode material usually comprises a positive electrode active substance, a binder, and a conductive agent. The positive electrode active substance may use commercially available positive electrode active substances, such as LiFePO₄, Li₃V₂(PO₄)₃, LiMn₂O₄, LiMnO₂, LiNiO₂, LiCoO₂, LiVPO₄F, or LiFeO₂; or ternary system Li₁₊ₐL_{1-b-c}M_{b}N_{c}O₂, in which −0.1≦a≦0.2, 0≦b≦1, 0≦c≦1, 0≦b+c≦1.0, and L, M, N are one or more of Co, Mn, Ni, Al, Mg, Ga, Sc, Ti, V, Cr, Fe, Cu and Zn.

The binder for the positive electrode can be any binders well known to those skilled in the art, such as one or more of PVDF, PTFE, and SBR. The binder content can be about 0.1-15% of the total weight of the positive electrode materials, preferably about 1-7%.

The conductive agent for the positive electrode can be any conductive agents well known to those skilled in the art, such as one or more of graphite, carbon fiber, carbon black, metal powder, and fiber. The content of the conductive agent can be about 0.1-20% of the positive electrode material total weights, preferably about 2-10%.

The method for preparing a positive electrode can be any traditional techniques in the field. In one example, a positive electrode active substance, a binder, and a conductive agent in a solvent are formulated into a slurry. The obtained slurry is coated onto a positive electrode current collector. Then the coated current collector is dried, pressed, and cut to provide a positive electrode. The drying temperature can be about 100-150° C. The drying time can be about 2-10 hours.

The solvent used in the positive electrode material slurry can be any solvents used in the field, such as one or more of N-methyl-2-pyrrolidinone (NMP), dimethylformamide (DMF), diethylformamide (DEF), dimethylsulfoxide (DMSO), tetrahydrofuran (THF), water, and alcohols. Any amount of the solvent well known to those skilled in the art can be used, and can be adjusted according to the viscosity of the slurry and the operation requirements. Generally, the amount of the solvent should allow the content of the positive electrode active substance in the slurry to be about 40-90% by weight, preferably about 50-85%.

In one embodiment, a lithium ion battery comprises a separator disposed between a positive electrode and a negative electrode. The separator has electric insulation property and liquid holding property. The separator can be selected from various separators well known to those skilled in the art, such as polyolefin microporous membranes, polyethylene felts, glass fiber felts or superfine glass fiber papers.

A non-aqueous electrolyte solution can be used in the lithium ion battery. The non-aqueous electrolyte solution is formed by dissolving an electrolyte in a non-aqueous solvent. The electrolyte is one or more selected from lithium hexafluorophosphate (LiPF₆), lithium perchlorate (LiClO₄), lithium tetrafluoroborate (LiBF₄), lithium hexafluoroarsenate(LiAsF₆), lithium hexafluorosilicate (LiSiF₆), lithium tetraphenylborate (LiB(C₆H₅)₄), lithium chloride (LiCl), lithium bromide (LiBr), lithium chloroaluminate (LiAlCl₄), and lithium fluorohydrocarbonylsulfonate (LiC(SO₂CF₃)₃, LiCH₃SO₃, LiN(SO₂—CF₃)₂). Suitable non-aqueous solvents include dimethyl carbonate (DMC), diethyl carbonate (DEC), ethyl methyl carbonate (EMC), methyl propyl carbonate (MPC), dipropyl carbonate (DPC), ethylene carbonate (EC), propylene carbonate (PC), vinylene carbonate (VC), γ-butyrolactone (γ-BL), sultone and the like. One or more of these solvents can be used. It is preferred that the aforementioned chain carbonic esters are used in combination with the aforementioned cyclic carbonic esters. The concentration of the lithium salt electrolyte can be about 0.1-2 mol/L, preferably about 0.8-1.2 mol/L.

In one embodiment of the present invention, the lithium ion battery can be prepared by any method well known to those skilled in the art. For example, the method comprises: (1) forming an electrode core by sequentially stacking and winding a positive electrode, a separator, and a negative electrode together; (2) disposing the electrode core into a battery case; (3) charging the electrolyte solution into the case; and (4) sealing the case to provide a lithium ion battery. Among the steps, the winding, stacking and sealing processes can use any techniques well known to those skilled in the art. The amount of the electrolyte solution can be any amount well known to those skilled in the art.

### EXAMPLE 1

The preparation of a positive electrode comprises: (1) adding LiCoO₂, conductive carbon black, and PVDF at a weight ratio of about 100:8:5 into N-methylpyrrolidone to form a first mixture; (2) stirring the first mixture; (3) coating the first mixture onto an aluminum foil; (4) drying the coated aluminum foil at about 90° C.; (5) rolling and pressing the coated aluminum foil; and (6) cutting the coated aluminum foil to a size of about 480 cm×42.5 cm to provide a positive electrode. The coat has a thickness of about 0.133-0.137 mm and contains about 6.35 g of LiCoO₂.

The preparation of a negative electrode comprises: (1) adding graphite, conductive carbon black and SBR at a weight ratio of about 100:4:8 into deionized water to form a second mixture; (2) stirring the second mixture to provide a first slurry; (3) coating the first slurry onto a copper foil; (4) drying the coated copper foil at about 90° C.; (5) rolling and pressing the coated copper foil to provide a primary electrode plate with a first coat in a thickness of about 0.105-0.109 mm; (6) adding Li₄Ti₅O₁₂, conductive carbon black, and SBR at a weight ratio of about 100:4:8 into deionized water to form a third mixture; (7) stirring the third mixture to provide a second slurry; (8) coating the second slurry onto the previously coated electrode plate; (9) drying the double-coated electrode plate at about 90° C.; (10) rolling and pressing the plate to obtain an electrode plate with a second coat in a thickness of about 0.009-0.013 mm; (11) cutting the electrode plate to a size of about 493 mm×44 mm to provide a negative electrode, which contains about 2.90 g of graphite and about 0.04 g of Li₄Ti₅O₁₂.

The preparation of a battery comprises: (1) stacking and winding the positive electrode, a polypropylene (PP) separator with a thickness of about 25 micron, and the negative electrode into a square lithium ion electrode core; (2) putting the electrode core into a square battery case; (3) injecting about 1 mol/L electrolyte (LiPF₆ in a mixture solvent of EC, DEC and DMC, the weight ratio of EC:DEC:DMC is about 1:1:1); (4) sealing the case to provide a square lithium ion battery with a thickness of about 5 mm, a width of about 34 mm, and a height of about 50 mm.

### EXAMPLE 2

A lithium ion battery was prepared as described in Example 1, except that the preparation of the negative electrode was different.

The preparation of the negative electrode comprises: (1) adding graphite and PVDF at a weight ratio of about 100:10 into deionized water to form a first mixture; (2) stirring the first mixture to provide a first slurry; (3) coating the first slurry onto a copper foil; (4) drying the coated electrode plate at about 90° C.; (5) rolling and pressing the coated plate to provide a primary electrode plate with a first coat in a thickness of about 0.075-0.079 mm; (6) adding Li_{3.95}Al0.15Ti_{0.49}O₁₂, carbon nanotubes, and PVDF at a weight ratio of 100:2:10 into deionized water to form a second mixture; (7) stirring the second mixture to provide a second slurry; (8) coating the second slurry onto the previously coated electrode plate; (9) drying the double-coated electrode plate at about 90° C.; (10) rolling and pressing the plate to provide an electrode plate with a second coat in a thickness of about 0.035-0.039 mm; (11) cutting the electrode plate to a size of about 493 mm×44 mm to provide a negative electrode, which contains about 1.25 g of Li_{3.95}Al_{0.15}Ti_{0.49}O₁₂ and about 2.60 g of carbon black

### EXAMPLE 3

A lithium ion battery was prepared according to the method in Example 1, except that the preparation of the negative electrode was different.

The preparation of the negative electrode comprises: (1) adding coke, nickel powder and PTFE at a weight ratio of about 100:5:6 into deionized water to form a first mixture; (2) stirring the first mixture to provide a first slurry; (3) coating the first slurry onto a copper foil; (4) drying the coated electrode plate at about 90° C.; (5) rolling and pressing the plate to provide a primary electrode plate with a first coat in a thickness of about 0.115-0.119 mm; (6) adding Li_{3.9}Mg_{0.1}Al_{0.15}Ti_{4.85}O₁₂, nickel powder, and PTFE at a weight ratio of about 100:12:8 into deionized water to form a second mixture; (7) stirring the second mixture to provide a second slurry; (8) coating the second slurry onto the previously coated electrode plate; (9) drying the double-coated electrode plate at about 90° C.; (10) rolling and pressing the electrode plate to provide an electrode plate with a second coat in a thickness of about 0.004-0.008 mm; (11) cutting the coated electrode plate in a size of about 493 mm×44 mm to provide a negative electrode, which contains about 0.03 g of Li_{3.9}Mg_{0.1}Al_{0.15}Ti_{4.85}O₁₂ and about 2.92 g of coke.

### EXAMPLE 4

A lithium ion battery was prepared according to the method in Example 1, except that the preparation of the negative electrode was different.

The preparation of the negative electrode comprises: (1) adding graphite, conductive carbon black, PTFE, and CMC at a weight ratio of about 100:8:2:1 into deionized water to form a first mixture; (2) stirring the first mixture to provide a first slurry; (3) coating the first slurry onto a copper foil; (4) drying the coated plate at about 90° C.; (5) rolling and pressing the plate to provide a primary electrode plate with a first coat in a thickness of about 0.108-0.112 mm; (6) adding Li_{3.95}Ga_{0.15}Ti_{0.49}O₁₂, copper powder, SBR, and CMC at a weight ratio of about 100:5:1:2 into deionized water to form a second mixture; (7) stirring the second mixture to provide a second slurry; (8) coating the second slurry onto the primary electrode plate; (9) drying the double-coated plate at about 90° C.; (10) rolling and pressing the plate to provide an electrode plate with a second coat in a thickness of about 0.013-0.017 mm; (11) cutting the coated electrode plate in a size of about 493 mm×44 mm to provide a negative electrode, which contains about 0.19 g of Li_{3.95}Ga_{0.15}Ti_{0.49}O₁₂ and about 2.86 g of graphite.

### EXAMPLE 5

A lithium ion battery was prepared according to the method in Example 1, except that the preparation of the negative electrode was different.

The preparation of the negative electrode comprises: (1) adding graphite, carbon black, Li₄Ti₅O₁₂, and SBR at a weight ratio of about 100:2:10:6 into deionized water to form a first mixture; (2) stirring the first mixture to provide a first slurry; (3) coating the first slurry onto a copper foil; (4) drying the coated plate at about 90° C.; (5) rolling and pressing the plate to provide a primary electrode plate with a first coat in a thickness of about 0.097-0.101 mm; (6) adding Li₄Ti₅O₁₂, graphite, and SBR at a weight ratio of about 100:10:8 into deionized water to form a second mixture; (7) stirring the second mixture to provide a second slurry; (8) coating the second slurry onto the primary electrode plate; (9) drying the coated plate at about 90° C.; (10) rolling and pressing the plate to provide an electrode plate with a second coat in a thickness of about 0.015-0.019 mm; (11) cutting the coated electrode plate in a size of about 493 mm×44 mm to provide a negative electrode, which contains about 0.34 g of Li₄Ti₅O₁₂ and about 2.64 g of graphite.

### EXAMPLE 6

A lithium ion battery was prepared according to the method in Example 1, except that the preparation of the negative electrode was different.

Preparation of the negative electrode comprises: (1) adding graphite, conductive carbon black, Li₄Ti₅O₁₂, and SBR at a weight ratio of about 100:2:16:6 into deionized water to form a first mixture; (2) stirring the first mixture to provide a first slurry; (3) coating the first slurry onto a copper foil; (4) drying the coated plate at about 90° C.; (5) rolling and pressing the coated plate to provide a primary electrode plate with a first coat in a thickness of about 0.089-0.093 mm; (6) adding Li₄Ti₅O₁₂, graphite, and SBR at a weight ratio of about 100:20:8 into deionized water to form a second mixture; (7) stirring the second mixture well to provide a second slurry; (8) coating the second slurry onto the primary electrode plate; (9) drying the coated plate at about 90° C.; (10) rolling and pressing the plate to provide an electrode plate with a second coat in a thickness of about 0.024-0.028 mm; (11) cutting the coated electrode plate in a size of about 493 mm×44 mm to provide a negative electrode, which contains about 0.23 g of Li₄Ti₅O₁₂ and about 2.40 g of graphite.

### COMPARISON EXAMPLE 1

This comparison example describes a secondary lithium ion battery with a negative electrode. The negative electrode has only one coating and contains the same material composition as that of Example 1.

Lithium ion battery was prepared according to the method in Example 1. The negative electrode has a size of about 493 mm×44 mm and only one coating in a thickness of about 0.116-0.120 mm. The coating comprises graphite, conductive carbon black, Li₄Ti₅O₁₂, and SBR at a weight ratio of about 100:4:1.4:8. The weight of graphite is about 2.9 g and the weight of Li₄Ti₅O₁₂ is about 0.04 g.

### COMPARISON EXAMPLE 2

This comparison example describes a secondary lithium ion battery.

A lithium ion battery was prepared according to the method in Example 1, except that the positive electrode has a thinner coat and contains less LiCoO₂, and the negative electrode material composition is different.

The positive electrode has a coat with a thickness of about 0.107-0.111 mm, containing about 4.80 g of LiCoO₂.

The negative electrode has a size of about 493 mm×44 mm. The coat on the negative electrode has a thickness of about 0.138-0.142 mm, comprising Li₄Ti₅O₁₂, conductive carbon black, and SBR at a weight ratio of about 100:4:8. The weight of Li₄Ti₅O₁₂ is about 4.74 g.

Battery Performance Test

1. Battery Capacity and Medium Voltage Test

At room temperature, the batteries in Examples 1-6 and Comparison Example 1 were charged to about 4.2 V at a current of about 1 C. The batteries were continued being charged at a constant voltage of about 4.2 V with a cut-off current of about 0.05 C, stabilized for about 5 minutes. Then the batteries were discharged to about 2.75 V at a current of about 1 C. The capacities of the batteries discharged to 2.75 V at a current of 1 C were obtained and the discharge medium voltage was recorded.

At room temperature, the battery in Comparison Example 2 was charged to about 3.0 V at a current of about 1 C, then continued being charged at a constant voltage of about 3.0 V, and cut off at a current of about 0.05 C, allowed to stand for about 5 minutes, then discharged to about 1.8 V at current of about 1 C. The capacity of the battery discharged to 1.8 V at a current of 1 C and room temperature was obtained and the discharge medium voltage was recorded.

The measured capacity and medium voltage for each battery are shown in Table 1.

TABLE 1

| | Medium | Battery |
|---|---|---|
| | Voltage (V) | Capacity (mAh) |
| Example 1 | 3.64 | 980 |
| Example 2 | 3.63 | 976 |
| Example 3 | 3.62 | 979 |
| Example 4 | 3.63 | 975 |
| Example 5 | 3.62 | 972 |
| Example 6 | 3.61 | 974 |
| Comparison Example 1 | 3.65 | 978 |
| Comparison Example 2 | 2.35 | 748 |

It can be seen from Table 1 that the batteries in Examples 1-6 and Comparison Example 1 have a high medium voltage and a high capacity; while the battery in Comparison Example 2 has a low medium voltage and a low capacity.

2. High Rate Performance Test

A. High Rate Discharge Test

At room temperature, the batteries in Examples 1-6 and Comparison Example 1 were charged to 4.2 V at a current of 1 C, then charged at constant voltage of 4.2 V and cut off at a current of 0.05 C, allowed to stand for 5 minutes, and discharged to 2.75 V at a current of 0.2 C. The capacity of the battery discharged to 2.75 V at a current of 0.2 C and room temperature was obtained. The charging procedures were repeated, the batteries were respectively discharged at a current of 3 C to obtain capacities of the batteries under this condition, and the discharge medium voltage was recorded. The charging procedures were further repeated, the batteries were respectively discharged at a current of 5 C to obtain capacities of the batteries, and the discharge medium voltage was recorded. The ratios of the capacities of the battery discharged at the current of 3 C and 5 C to that of the battery discharged at the current of 0.2 C were respectively calculated (abbreviated as discharge ratio of 3 C/0.2 C and 5 C/0.2 C below).

At room temperature, the battery prepared in Comparison Example 2 was charged to 3.0 V at current of 1 C, charged at a constant voltage of 3.0 V and cut off at a current of 0.05 C, allowed to stand for 5 minutes, and discharged to 1.8 V at a current of 0.2 C to obtain a capacity of the battery. The charging procedures were repeated, the battery was discharged at a current of 3 C to obtain a capacity of the battery at this condition, and the discharge medium voltage is recorded. The charging procedures were further repeated, the battery was discharged at a current of 5 C to obtain capacity of the battery and the discharge medium voltage is recorded. The ratios of the capacities of the battery discharged at the current of 3 C and 5 C to that of the battery discharged at the current of 0.2 C were respectively calculated (abbreviated as discharge ratio of 3 C/0.2 C and 5 C/0.2 C below).

The obtained discharge ratios of 3 C/0.2 C and 5 C/0.2 C, and discharge medium voltage are shown in Table 2.

TABLE 2

3 C

| | Discharge | Medium | 5 C | |
|---|---|---|---|---|
| | Ratio of 3 C/ | Voltage | Discharge Ratio | Medium |
| | 0.2 C (%) | (V) | of 5 C/0.2 C (%) | Voltage (V) |
| Example 1 | 92.4% | 3.55 | 86.4% | 3.52 |
| Example 2 | 89.2% | 3.54 | 85.6% | 3.48 |
| Example 3 | 91.5% | 3.56 | 84.5% | 3.46 |
| Example 4 | 91.8% | 3.56 | 84.9% | 3.51 |
| Example 5 | 88.5% | 3.53 | 84.2% | 3.47 |
| Example 6 | 88.0% | 3.53 | 83.9% | 3.46 |
| Comparison | 81.4% | 3.48 | 72.7% | 3.40 |
| Example 1 | | | | |
| Comparison | 91.4% | 2.31 | 86.1% | 2.28 |
| Example 2 | | | | |

It can be seen from Table 2 that in comparison of the ratio of the discharge capacity under high rate to that under current of 0.2 C, the batteries in Examples 1-6 have equal or slightly lower values compared to the one in Comparison Example 2; while the battery in Comparison Example 1 has a significantly lower ratio than Comparison Example 2.

B. High Rate Charge Test

At room temperature, the batteries in Examples 1-6 and Comparison Example 1 were respectively charged to 4.2 V at a current of 0.2 C, charged at a constant voltage of 4.2 V and cut off at a current of 0.05 C, allowed to stand for 5 minutes, and discharged to 2.75 V at a current of 1 C to obtain a capacity of the battery charged to 4.2 V at a current of 0.2 C and then discharged to 2.75 V at a current of 1 C and room temperature. The batteries were respectively charged to 4.2 V at a current of 3 C, charged at a constant voltage of 4.2 V and cut off at current of 0.05 C, allowed to stand for 5 minutes, and discharged to 2.75 V at a current of 1 C to obtain a capacity of the battery charged to 4.2 V at a current of 3 C and then discharged to 2.75 V at current of 1 C and room temperature. The batteries were respectively charged to 4.2 V at a current of 5 C, charged at a constant voltage of 4.2 V and cut off at a current of 0.05 C, allowed to stand for 5 minutes, and discharged at a current of 1 C to 2.75 V to obtain a capacity of the battery charged to 4.2 V at current of 5 C and then discharged to 2.75 V at a current of 1 C and at room temperature. The ratios of the discharge capacities of the battery charged at the current of 3 C and 5 C to that of the battery charged at the current of 0.2 C were respectively calculated.

At room temperature, the battery in Comparison Example 2 was charged to 3.0 V at a current of 0.2 C, charged at a constant voltage of 3.0 V and cut off at a current of 0.05 C, allowed to stand for 5 minutes, and discharged at a current of 1 C to 1.8 V to obtain capacity of the battery charged to 3.0 V at current of 0.2 C and then discharged to 1.8 V at a current of 1 C and room temperature. Then the battery was charged to 3.0 V at current of 3C, charged at constant voltage of 3.0 V and cut off at current of 0.05 C, allowed to stand for 5 minutes, and discharged at current of 1 C to 1.8 V to obtain capacity of the battery charged to 3.0 V at current of 3 C and then discharged to 1.8 V at current of 1 C and room temperature; and the battery was charged to 3.0 V at current of 5 C, charged at constant voltage of 3.0V and cut off at current of 0.05 C, allowed to stand for 5 minutes, and discharged at current of 1 C to 1.8 V to obtain capacity of the battery charged to 3.0 V at current of 5 C and then discharged to 1.8 V at current of 1 C and at room temperature. The ratios of the discharge capacities of the battery charged at current of 3 C and 5 C to that of the battery charged at current of 0.2 C were respectively calculated (abbreviated as discharge ratio of 3 C/0.2 C and 5 C/0.2 C below).

The obtained discharge ratios of 3 C/0.2 C and 5 C/0.2 C are shown in Table 3.

TABLE 3

| | Discharge | Discharge |
|---|---|---|
| | Ratio of 3 C/0.2 C (%) | Ratio of 5 C/0.2 C (%) |
| Example 1 | 94.3% | 87.6% |
| Example 2 | 91.7% | 85.8% |
| Example 3 | 93.2% | 86.7% |
| Example 4 | 92.9% | 86.0% |
| Example 5 | 91.8% | 85.0% |
| Example 6 | 91.4% | 84.2% |
| Comparison | 85.7% | 76.5% |
| Example 1 | | |
| Comparison | 94.2% | 87.9% |
| Example 2 | | |

It can be seen from the Table 3 that in comparison of the ratio of the discharge capacity under high rate to that under current of 0.2 C, the batteries in Examples 1-6 have equal or slightly lower values compared to the battery in Comparison Example 2; while the battery in Comparison Example 1 has a significantly lower ratio than Comparison Example 2.

3. Safety Performance Test

A. Oven Temperature Test

At room temperature, the batteries in Examples 1-6 and Comparison Example 1 awere respectively charged to 4.2 V at a current of 1 C, and the battery in Comparison Example 2 was charged to 3.0 V at a current of 1 C. Then the batteries were charged at constant voltages of 4.2 V and 3.0 V, respectively, and cutoff at a current of 0.05 C, allowed to stand for 5 minutes, and disposed in a 150° C. oven. After 1.5 hours, the batteries were observed for abnormal appearance, and tested for maximum surface temperature of the batteries. The observation and measurement results are shown in Table 4.

TABLE 4

| | | Maximum Temperature of |
|---|---|---|
| | Battery Appearance | Battery Surface (° C.) |
| Example 1 | bulged | 151.4 |
| Example 2 | bulged | 151.8 |
| Example 3 | bulged | 152.4 |
| Example 4 | bulged | 151.7 |
| Example 5 | bulged | 152.2 |
| Example 6 | bulged | 151.3 |
| Comparison | Bulged, electrolyte | 155.4 |
| Example 1 | leakage | |
| Comparison | bulged | 152.1 |
| Example 2 | | |

It can be seen from the Table 4 that the batteries in Examples 1-6 have a equal or higher safety performance than the one in Comparison Example 2. The battery in Comparison Example 1 has poor safety performance.

B. Electrode Surface Lithium Concentration Test

At room temperature, the batteries in Examples 1-6 and Comparison Example 1 were respectively charged to 4.2 V at a current of 5 C, and the battery in Comparison Example 2 is charged to 3.0 V at a current of 5 C. Then the batteries were respectively charged at a constant voltage of 4.2 V and 3.0 V and cut off at a current of 0.05 C, allowed to stand for 5 minutes. The batteries were disassembled under inert gas atmosphere. The negative electrodes were taken out and observed by naked eyes. The XPS test was performed immediately to measure lithium concentration on the surfaces of the negative electrodes. The observation result and lithium concentration on the negative electrode surface are shown in Table 5.

TABLE 5

| | Negative Electrode | Negative Electrode Surface Lithium |
|---|---|---|
| | Appearance | Concentration (wt %) |
| Example 1 | Normal | 14.5 |
| Example 2 | Normal | 15.8 |
| Example 3 | Normal | 16.3 |
| Example 4 | Normal | 20.5 |
| Example 5 | Normal | 18.1 |
| Example 6 | Normal | 22.4 |
| Comparison | Many White spots | 45.2 |
| Example 1 | | |
| Comparison | Normal | 13.7 |
| Example 2 | | |

It can be seen from the Table 5 that the batteries in Examples 1-6 and Comparison Example 2 have low lithium concentrations on the negative electrode surface and good safety performances; and the battery in Comparison Example 1 has a high lithium concentration on the negative electrode surface and poor safety performances.

C. Short Circuit Test

At room temperature, the batteries in the examples 1-6 and Comparison Example 1 were respectively charged to 4.2 V at a current of 5 C, and the battery in Comparison Example 2 was charged to 3.0 V at a current of 5 C. Then the batteries were respectively charged at constant voltages of 4.2 V and 3.0 V and cut off at a current of 0.05 C, allowed to stand for 5 minutes. A thermal couple probe was attached to the surfaces of the batteries. A short circuit device places the negative electrode and the positive electrode in short circuit state. The battery appearance and maximum temperature on the battery surface were observed and recorded. The results are shown in Table 6.

TABLE 6

| | | Battery Surface Maximum |
|---|---|---|
| | Battery Appearance | Temperature (° C.) |
| Example 1 | bulged | 112.4 |
| Example 2 | bulged | 114.5 |
| Example 3 | bulged | 115.2 |
| Example 4 | bulged | 114.9 |
| Example 5 | bulged | 115.7 |
| Example 6 | bulged | 116.3 |
| Comparison | Bulged, electrolyte | 182.3 |
| Example 1 | leakage | |
| Comparison | bulged | 113.1 |
| Example 2 | | |

It can be learned from the Table 6 that the batteries in the Examples 1-6 and the comparison example 2 have good safety performances; and the battery in Comparison Example 1 has a poor safety performance.

4. Negative Electrode Capacity Test

The negative electrode in Examples 1-6 and Comparison Example 1 were cut to round plates with a diameter of about 14 mm. A mixture with composition identical to the negative electrode materials in the Comparison Example 2 was used to form a negative electrode coat with a thickness of about 0.116-0.120 mm. Then the negative electrode was cut into a round plate with a diameter of about 14 mm. Button cells were prepared by using the obtained round plates as positive electrodes, and metal lithium plates as negative electrode. The obtained cells were discharged to 0.005 V at a current of 0.2 mA, allowed to stand for 5 minutes, and charged to 2.5 V at a current of 0.2 mA, charged at a constant voltage of 2.5 V and cut off at a current of 0.01 mA. The capacity for each button cell was recorded as the negative electrode capacity for each battery. The test results are shown in Table 7.

TABLE 7

| | Negative Electrode Capacity (mAh) |
|---|---|
| Example 1 | 1.96 |
| Example 2 | 1.82 |
| Example 3 | 2.07 |
| Example 4 | 1.91 |
| Example 5 | 1.89 |
| Example 6 | 1.85 |
| Comparison Example 1 | 1.93 |
| Comparison Example 2 | 1.25 |

It can be seen from Table 7 that the negative electrodes in Examples 1-6 and Comparison Example 1 have high capacities, while the negative electrode in Comparison Example 2 has a low capacity.

The performance test result shows that the lithium ion battery has a capacity of higher than about 970 mAh and a voltage of higher than about 3.6 V. The lithium ion battery in Comparison Example 2 has a capacity of about 748 mAh and a voltage of less than 3.2 V. The capacity of the disclosed negative electrode in a button cell is higher than 1.8 mAh, while the currently available negative electrode has a capacity of 1.25 mAh. The battery in Comparison Example 1 with only one layer coat is poor in the tested performances. The lithium ion batteries in the present disclosure have high capacities and voltages, and are surprisingly good in cycle performances, high-rate discharge-charge performances, and safety performances.

Many modifications and other embodiments of the present disclosure will come to mind to one skilled in the art to which the present disclosure pertains having the benefit of the teachings presented in the foregoing description; and it will be apparent to those skilled in the art that variations and modifications of the present disclosure can be made without departing from the scope or spirit of the present disclosure. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A negative electrode for a battery, comprising
a current collector;
an inner coating on the current collector; and
an outer coating on the inner coating;
wherein the inner and outer coatings comprise a carbonaceous material, and a lithium titanium oxide compound;
wherein the weight percentage of the carbonaceous material is higher than that of the lithium titanium oxide compound in the inner coating;
wherein the weight percentage of the carbonaceous material is lower than that of the lithium titanium oxide compound in the outer coating; and
wherein the total weight percentage of the carbonaceous material in the combined inner and outer coatings is higher than the total weight percentage of the lithium titanium oxide compound in the combined inner and outer coatings.

2. The negative electrode of claim 1, wherein the ratio of the weight percentage of the carbonaceous material to that of the lithium titanium oxide compound is equal to or more than about 1:0.25 in the inner coating.

3. The negative electrode of claim 1, wherein the ratio of the weight percentage of the carbonaceous material to that of the lithium titanium oxide compound is equal to or less than about 0.25:1 in the outer coating.

4. The negative electrode of claim 1, wherein the ratio of the total weight percentage of the carbonaceous material to that of the lithium titanium oxide compound is in a range of about 1.5:1 to about 100:1.

5. The negative electrode of claim 1, wherein the carbonaceous material is selected from the group consisting of graphite, carbon black, coke, activated carbon, carbon fiber, petroleum coke, hard carbon, carbon nanotubes and combinations thereof.

6. The negative electrode of claim 1, wherein the lithium titanium oxide compound includes one or more lithium titanium oxide materials with chemical formula of Li₃₊₃ₓTi_{6-3x-y}M_{y}O₁₂, wherein x and y are molar fractions, wherein 0≦x≦⅓, 0≦y≦0.25; and M is selected from the group consisting of Fe, Al, Ca, Co, B, Cr, Ni, Mg, Zr, Ga, V, Mn, Zn, and combinations thereof.

7. The negative electrode of claim 1, wherein the inner coating comprises at least two layers.

8. The negative electrode of claim 1, wherein the outer coating comprises at least two layers.

9. The negative electrode of claim 1, wherein the inner and outer coatings further comprise a binder.

10. The negative electrode of claim 9, wherein the binder is selected from the group consisting of polyvinylidene fluoride, polytetrafluoroethylene, sodium carboxymethylcellulose, styrene-butadiene rubber, and combinations thereof.

11. The negative electrode of claim 1, wherein the inner and outer coatings further comprise a conductive agent.

12. The negative electrode of claim 11, wherein the conductive agent is selected from a group consisting of nickel powder, copper powder, and a combination thereof.

13. A negative electrode for a battery, comprising
a current collector;
an inner coating on the current collector; and
an outer coating on the inner coating;
wherein the inner and outer coatings comprise a carbonaceous material, and a lithium titanium oxide compound;
wherein the weight percentage of the carbonaceous material is higher than that of the lithium titanium oxide compound in the inner coating;
wherein the weight percentage of the carbonaceous material is lower than that of the lithium titanium oxide compound in the outer coating;
wherein the total weight percentage of the carbonaceous material in the combined inner and outer coatings is higher than the total weight percentage of the lithium titanium oxide compound in the combined inner and outer coatings; and
wherein each of the inner and outer coatings comprises one layer.

14. The negative electrode of claim 13, wherein the inner coating has a thickness of about 0.070-0.120 mm.

15. The negative electrode of claim 13, wherein the outer coating has a thickness of about 0.003-0.040 mm.

16. The negative electrode of claim 13, wherein the ratio of the thickness of the inner coating to the outer coating is in a range of about 50:25 to about 50:2.

17. The negative electrode of claim 13, wherein the inner coating comprises about 80-95% of the carbonaceous material by weight and no more than 16% of the lithium titanium oxide compound by weight.

18. The negative electrode of claim 13, wherein the outer coating comprises no more than 16% of the carbonaceous material by weight and about 80-95% of the lithium titanium oxide compound by weight.

19. The negative electrode of claim 13, the inner and outer coatings further comprises a binder.

20. The negative electrode of claim 19, wherein the inner coating comprises about 1-10% of the binder by weight.

21. The negative electrode of claim 13, the inner and outer coatings further comprises a conductive agent.

22. The negative electrode of claim 21, wherein the outer coating comprises no more than 8% of the conductive agent by weight.

23. A lithium ion battery, comprising:
a negative electrode, comprising
a current collector;
an inner coating on the current collector; and
an outer coating on the inner coating;
wherein the inner and outer coatings comprise a carbonaceous material, and a lithium titanium oxide compound;
wherein the weight percentage of the carbonaceous material is higher than that of the lithium titanium oxide compound in the inner coating;
wherein the weight percentage of the carbonaceous material is lower than that of the lithium titanium oxide compound in the outer coating; and
wherein the total weight percentage of the carbonaceous material in the combined inner and outer coatings is higher than the total weight percentage of the lithium titanium oxide compound in the combined inner and outer coatings;
a positive electrode, comprising
a current collector; and
a coating on the current collector;
a separator;
an electrolyte; and
a case;
wherein the negative electrode, the positive electrode, the separator, and the electrolyte are disposed in the case.

24. The lithium ion battery of claim 23, wherein the positive electrode material is selected from the group consisting of LiFePO₄, Li₃V₂(PO₄)₃, LiMn₂O₄, LiMnO₂, LiNiO₂, LiCoO₂, LiVPO₄F, LiFeO₂, and combinations thereof.

25. The lithium ion battery of claim 23, wherein the positive electrode material comprises a compound of formula Li₁₊ₐL_{1-b-c}M_{b}N_{c}O₂, wherein a is no less than about 0.1 and no more than about 0.2, b is no more than about 1, c is no more than about 1, b+c is no more than about 1, and wherein L, M, N are selected from Co, Mn, Ni, Al, Mg, Ga, any metal from Family 3d, and combinations thereof.

26. The lithium ion battery of claim 23, wherein the electrolyte comprises a lithium salt and a non-aqueous solvent.

27. The lithium ion battery of claim 26, wherein the lithium salt is selected from the group consisting of lithium hexafluorophosphate (LiPF₆), lithium perchlorate (LiClO₄), lithium tetrafluoroborate (LiBF₄), lithium hexafluoroarsenate(LiAsF₆), lithium hexafluorosilicate (LiSiF₆), lithium tetraphenylborate (LiB(C₆H₅)₄), lithium chloride (LiCl), lithium bromide (LiBr), lithium chloroaluminate (LiAlCl₄), lithium fluorohydrocarbonylsulfonate (LiC(SO₂CF₃)₃, LiCH₃SO₃, LiN(SO₂—CF₃)₂), and combinations thereof.

28. The lithium ion battery of claim 26, wherein the non-aqueous solvent is selected from the group consisting of dimethyl carbonate (DMC), diethyl carbonate (DEC), ethyl methyl carbonate (EMC), methyl propyl carbonate (MPC), dipropyl carbonate (DPC), ethylene carbonate (EC), propylene carbonate (PC), vinylene carbonate (VC), γ-butyrolactone (γ-BL), and combinations thereof.

29. The lithium ion battery of claim 23, wherein the electrolyte comprises LiPF₆ and a solvent.

30. The lithium ion battery of claim 29, wherein the solvent is selected from the group consisting of ethylene carbonate (EC), diethyl carbonate (DEC), dimethyl carbonate (DMC), and combinations thereof.
